(19) United States
(12) Patent Application Publication
(10) Pub. No.: US 2018/0164460 A1
(43) Pub. Date: Jun. 14, 2018

(54) Dipole-Type Source for Generating Low Frequency Pressure Wave Fields

(71) Applicant: PGS Geophysical AS, Oslo (NO)

(72) Inventor: Walter F. Söllner, Oslo (NO)

(73) Assignee: PGS Geophysical AS, Oslo (NO)

(21) Appl. No.: 15/816,801

(22) Filed: Nov. 17, 2017

Related U.S. Application Data
(60) Provisional application No. 62/433,326, filed on Dec. 13, 2016.

(51) Int. Cl. G01V 1/38

(52) U.S. Cl. CPC G01V 1/3843; G01V 1/3808

(57) ABSTRACT

Disclosed are directed to dipole-type sources and associated methods and systems. A dipole-type source may comprise a first bender plate and a second bender plate. The dipole-type source may further comprise a first cavity coupled to the first bender plate and a second cavity coupled to the second bender plate. The dipole-type source may further comprise one or more drivers in fluid communication with the first cavity and/or the second cavity, wherein the one or more drivers are operable to drive a respective fluid between at least one of the one or more drivers and the first cavity and between at least one of the one or more drivers and the second cavity, such that the first and second bender plate oscillate at least substantially synchronously in the same direction to generate an up-going wave and a down-going wave with opposite polarity.

### CROSS-REFERENCE TO RELATED APPLICATIONS

The present application claims the benefit of U.S. Provisional Application No. 62/433,326, filed Dec. 13, 2016, entitled “Dipole-Type Source for Generating Very Low Frequency Pressure Wavefields,” the entire disclosure of which is incorporated herein by reference.

### BACKGROUND

Techniques for marine surveying include marine seismic surveying, in which geophysical data may be collected from below the Earth's surface. Marine seismic surveying has applications in mineral and energy exploration and production to help identify locations of hydrocarbon-bearing formations. Marine seismic surveying typically may include towing a seismic source below or near the surface of a body of water. One or more “streamers” may also be towed through the water by the same or a different vessel. The streamers are typically cables that include a plurality of sensors disposed thereon at spaced apart locations along the length of each cable. Some seismic surveys locate sensors on ocean bottom cables or nodes in addition to, or instead of, streamers. The sensors may be configured to generate a signal that is related to a parameter being measured by the sensor. At selected times, the seismic source may be actuated, for example, to generate a pressure wave field. The sensors may measure the pressure wave field at a particular point, including pressure waves in the pressure wave field affected by interaction with subsurface formations. The measurements of the pressure wave field may be used to infer certain properties of the subsurface formations, such as structure, mineral composition, and fluid content, thereby providing information useful in the recovery of hydrocarbons.

It is well known that as pressure waves travel through water and through subsurface formations, higher frequency pressure waves may be attenuated more rapidly than lower frequency pressure waves, and consequently, lower frequency pressure waves can be transmitted over longer distances through water and geological structures than higher frequency pressure waves. In addition, the lowest frequency range can be important for deriving the elastic properties of the subsurface by seismic full wave field inversion (FWI). Accordingly, there has been a need for powerful low frequency marine sound sources operating in the frequency band of 1-100 hertz (“Hz”) and, as low as 2 to 3 octaves below 6 Hz. However, generation of low frequency pressure wave fields from seismic sources based on volume injection, such as air guns, marine vibrators, benders, etc., hereinafter referred to as “monopole-type sources,” may be limited by a ghost function of the monopole-type source, in which the pressure wave fields that propagate toward the water surface are reflected at the water-air interface. These reflected waves, commonly referred to as “ghosts,” have the opposite polarity of the up-going waves and propagate toward the water bottom. The ghosts interfere with the pressure waves from the sound source going downwards toward the bottom and act as a filter on the reflected wave field. The amplitude spectrum of a monopole-type ghost filter G(ω)=1−e^{-iωτ} (with τ vertical delay time) is sine shaped with amplitude zero at k*water_velocity/(2*source_depth) Hz (and maxima in the middle between two zero crossings) for k=0, 1, 2, etc. Thus, the amplitude of the monopole-type source may approach zero at 0 Hz.

### BRIEF DESCRIPTION OF THE DRAWINGS

These drawings illustrate certain aspects of some of the embodiments of the present disclosure and should not be used to limit or define the disclosure.

FIGS. 1A to 1C illustrate example embodiments of a dipole-type source.

FIGS. 2A and 2B illustrate example embodiments of generation of pressure waves in a body of water.

FIG. 3 illustrates an example model for calculating a pressure wave field generated by a dipole-type source.

FIGS. 4 and 5 illustrate computed pressure wave fields from a monopole-type source in accordance with example embodiments.

FIGS. 6 and 7 illustrate computed pressure wave fields from a dipole-type source in accordance with example embodiments.

FIG. 8 illustrates computed pressure wave fields including the source ghost from a dipole-type source in accordance with example embodiments.

FIG. 9 illustrates computed pressure wave fields including the source ghost from a monopole-type source in accordance with example embodiments.

FIGS. 10A to 10C illustrate an example embodiment of a dipole-type source.

FIG. 11 illustrates an example embodiment of a stack assembly of dipole-type sources.

FIG. 12 illustrates an example embodiment of a marine seismic survey system.

### DETAILED DESCRIPTION

Embodiments may be directed to dipole-type sources and associated methods and systems. At least one embodiment may be directed to a dipole-type source used for marine seismic survey systems, wherein the dipole-type source may generate an up-going wave and a down-going wave with opposite polarity. This type of source that generates an up-going wave and a down-going wave with opposite polarity may be referred to as a “dipole-type source.” It should be understood that the up-going wave is not required to travel upwards in a direction normal to the water surface, but instead emanates from the dipole-type source and travels generally upward toward the water surface, while the down-going wave emanates from the dipole-type source and travels generally downward towards the water bottom.

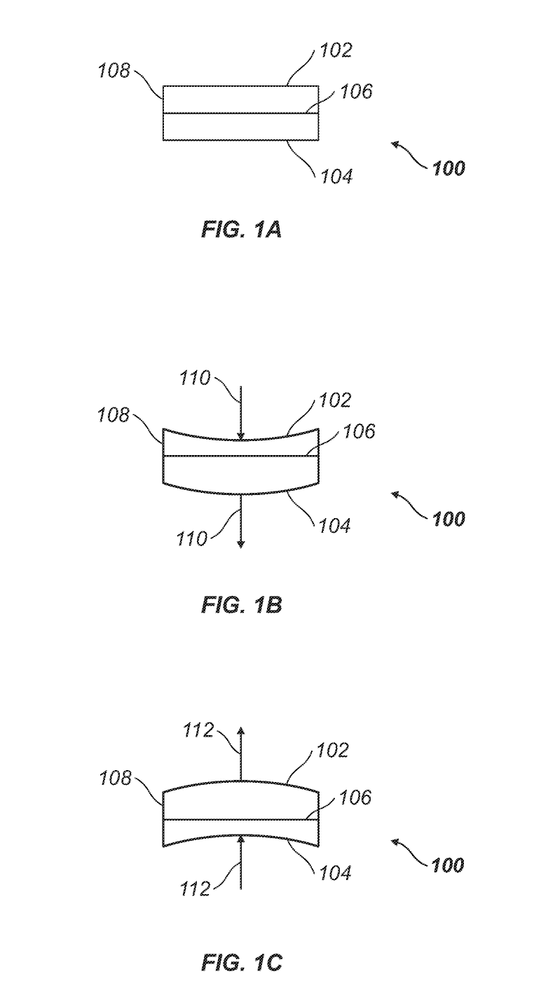

FIGS. 1A to 1C illustrate an example embodiment of a dipole-type source 100. As illustrated, dipole-type source 100 may include two sound radiating surfaces, in the form of first bender plate 102 and second bender plate 104, to generate pressure waves. In the illustrated embodiment, first and second bender plates 102, 104 may bend and flex to generate pressure waves. First bender plate 102 and second bender plate 104 may each act in a phase opposite to the other such that first and second bender plates 102, 104 oscillate substantially synchronously in the same direction such that dipole-type source 100 may generate an up-going wave and a down-going wave with opposite polarity. As used herein, the two sound radiating surfaces (e.g., first bender plate 102 and second bender plate 104) are considered to oscillate substantially synchronously where at least 95% of their oscillation is in the same direction. For example, at least 95%, 98%, 99%, or 99.9% of the oscillation of the sound radiating surfaces (e.g., first bender plate 102 and second bender plate 104) may be in the same direction. Dipole-type source 100 may act by change of momentum and the amplitude spectra of a dipole-type ghost filter G(ω)=1+e^{-iωτ} (with τ vertical delay time) is cosine shaped with amplitude zero at (k+½)*water_velocity/(2*source_depth) Hz (and maxima in the middle between two zero crossings) for k=0, 1, 2, etc. Thus, the amplitude of the ghost function approaches its first maximum when the frequencies approach 0 Hz. Thus, dipole-type source 100 may be suited for generating very low frequencies, for example, from about 0.75 Hz to about 6 Hz, and specifically, from about 3 Hz to about 6 Hz, about 1.5 Hz to 3 Hz, or about 0.75 Hz to 1.5 Hz. Further, while combining first and second bender plates 102, 104, which ordinarily function separately as a monopole-type source, with a dipole-type source, a pressure wave field with decomposed upward and downward propagation can be generated, which are free of spectral notches. In other words, source side wave field separation can be achieved. While FIGS. 1A to 1C illustrate dipole-type source 100 in the form of a “bender” (also commonly referred to as a “flexural-disc projector”), the disclosure is not limited to dipole-type source 100 being a bender. In alternative embodiments, dipole-type source 100 may be in the foul′ or an acoustic vibratory source, a piston plate type source, or other suitable device for generating the desired pressure waves.

In the illustrated embodiment, dipole-type source 100 includes first and second bender plates 102, 104. While not illustrated, springs and mass elements may be attached to first and second bender plates 102, 104 as desired for a particular application. In some embodiments, first and second bender plates 102, 104 may be generally planar. In particular embodiments, first and second bender plates 102, 104 may each be in the form of a flexible disk. In embodiments, the first and second bender plates 102, 104 may each be flat, circular disks having substantially uniform thickness. However, other configurations of first and second bender plates 102, 104, including both axially-symmetric and axially-asymmetric, may be suitable for particular applications. By way of example, first and second bender plates 102, 104 may be rectangular, square, elliptical, or other suitable shape for providing the desired pressure waves. First and second bender plates 102, 104 may be made from any of a variety of materials including materials comprising steel, aluminum, a copper alloy, glass-fiber reinforced plastic (e.g., glass-fiber reinforced epoxy), carbon fiber reinforced or other suitable flexible spring material. Examples of suitable copper alloys may include brass, beryllium, copper, phosphor bronze, or other suitable copper alloy. In some embodiments, first and second bender plates 102, 104 may comprise aluminum. First and second bender plates 102, 104 may be made from the same or a different material. In particular embodiments, first and second bender plates 102, 104 may have a thickness from about 1 millimeter to about 12 millimeters or even greater. However, dimensions outside these ranges may be suitable for a particular application, as desired by one of ordinary skill in the art with the benefit of this disclosure. In general, first and second bender plates 102, 104 should have a thickness that allows sufficient deformation but can withstand expected differential static pressures.

First and second bender plates 102, 104 may be coupled together or otherwise positioned to provide an internal cavity 106 between first and second bender plates 102, 104. First and second bender plates 102, 104 may also be coupled to one another in a manner that allows first and second bender plates 102, 104 to bend and generate the desired pressure waves. In particular embodiments, first and second bender plates 102, 104 may be coupled to one another at their outer edges. In one non-limiting embodiment, first and second bender plates 102, 104 may be coupled together by outer wall 108. Outer wall 108 may be in the form of a hoop or other suitable structure. Outer wall 108 may be sized to maintain a separation (e.g., a gap) between first and second bender plates 102, 104.

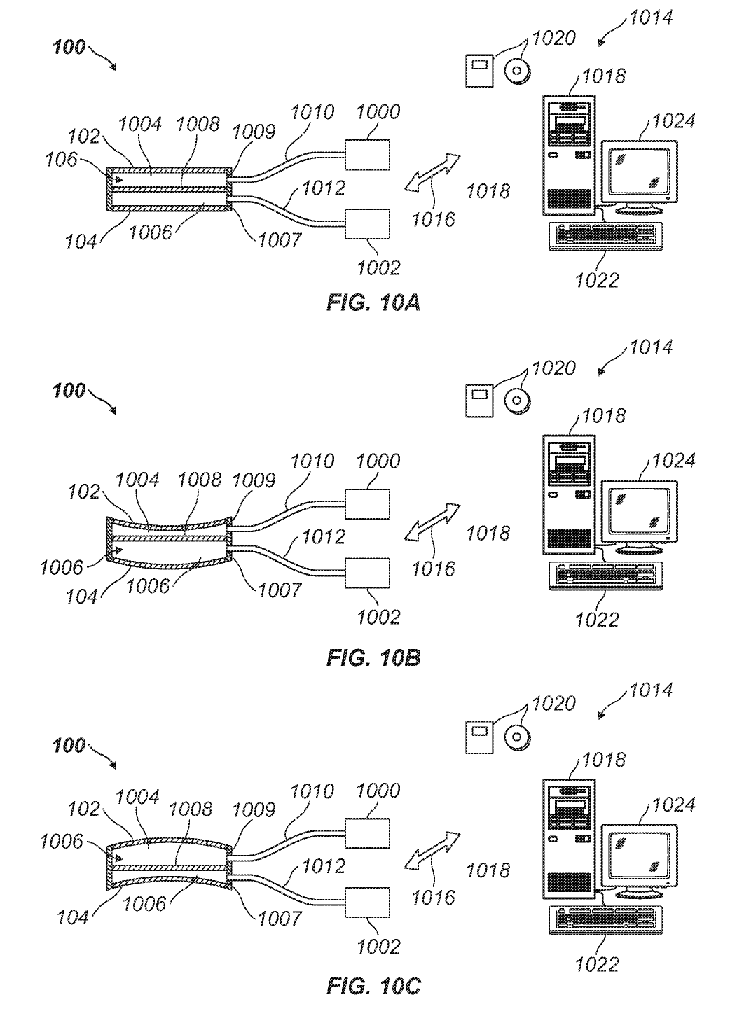

Operation of dipole-type source 100 will now be described in more detail with reference to FIGS. 1A to 1C. FIG. 1A illustrates dipole-type source 100 including first and second bender plates 102, 104 at rest. A driver (e.g., one or more drivers 1000, 1002 shown in FIG. 10A) may be operated to cause first and second bender plates 102, 104 to bend such that they oscillate substantially synchronously. First and second bender plates 102, 104 may bend in substantial synchrony in a first direction shown by arrows 110 (FIG. 1B) to create positive pressure below and negative pressure above dipole-type source 100. Then, bend in substantial synchrony in a second direction as shown by arrows 112 (FIB. 1C) to create positive pressure above and negative pressure below dipole-type source 100. This oscillating movement may be repeated for a period of time to generate a pressure wave field. As first and second bender plates 102, 104 oscillate in substantial synchrony, dipole-type source 100 may generate an up-going wave and a down-going wave with opposite polarity. As can be seen on FIGS. 1B and 1C the first and second bender plates 102, 104 bend in the same direction substantially synchronously without a total volume change in internal cavity 106, for example, a volume change in internal cavity of less than 1%, less than 0.5%, or even less.

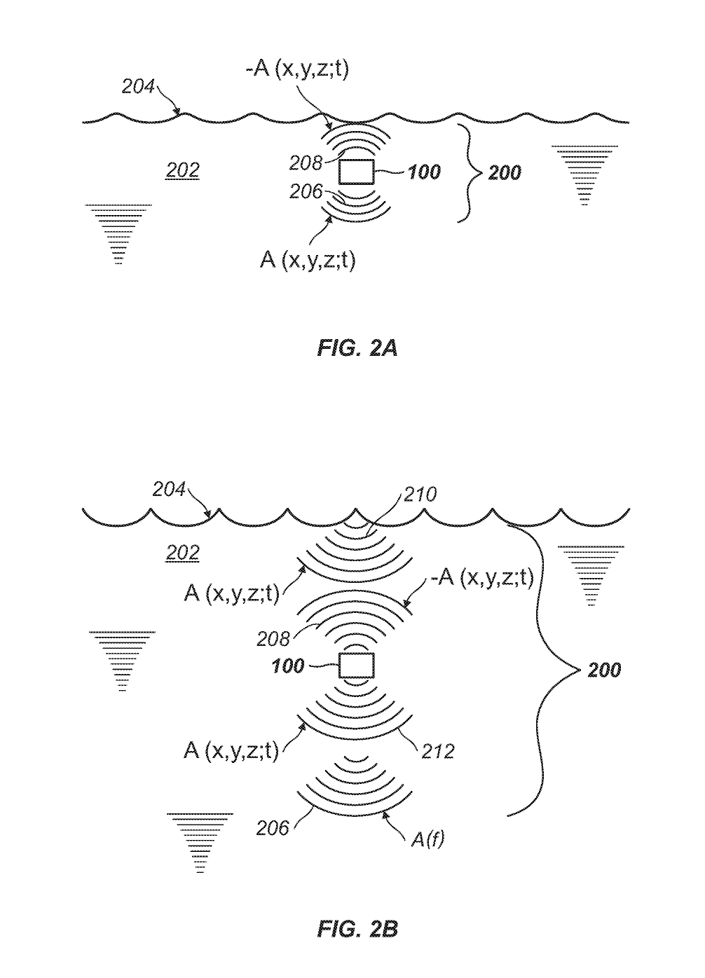

FIG. 2A illustrates generation of a pressure wave field 200 in body of water 202 by dipole-type source 100 in accordance with example embodiments. Dipole-type source 100 may be positioned in body of water 202 below a water surface 204. Dipole-type source 100 may be operated in body of water 202 to generate pressure waves with opposite polarity, illustrated on FIG. 2A as down-going wave 206 and up-going wave 208 with opposite polarity. Down-going wave 206 may be at a low frequency. In some embodiments, down-going wave 206 may have a very low frequency, for example, from about 0.75 Hz to about 10 Hz, and specifically, from about 3 Hz to about 6 Hz, about 1.5 Hz to 3 Hz, or about 0.75 Hz to 1.5 Hz. The down-going wave 206 and the up-going wave 208 are considered to have opposite polarity where the pressure amplitude at the same distance from the source has an opposite sign. For example, down-going wave 206 may have a pressure amplitude A(x,y,z;t), while up-going wave 208 may be created with reverse polarity, or have a pressure amplitude at the same distance from the source−A(x,y,−z;t), assuming the origin of a Cartesian coordinate system at the center of the source with positive z-axis pointing downwards. Up-going wave 208 may also be at a low frequency. In some embodiments, up-going wave 208 may have a very low frequency, for example, from about 0.75 Hz to about 10 Hz, and specifically, from about 3 Hz to about 6 Hz, about 1.5 Hz to 3 Hz, or about 0.75 Hz to 1.5 Hz. As illustrated by FIG. 2B, up-going wave 208 may be reflected off water surface 204 to provide reflected wave 210, which may then have the same polarity as the down-going wave 206. At low frequencies, these two down-going waves (e.g., down-going wave 206 and reflected wave 210) may combine substantially in-phase to provide a composite wave 212 that is down going.

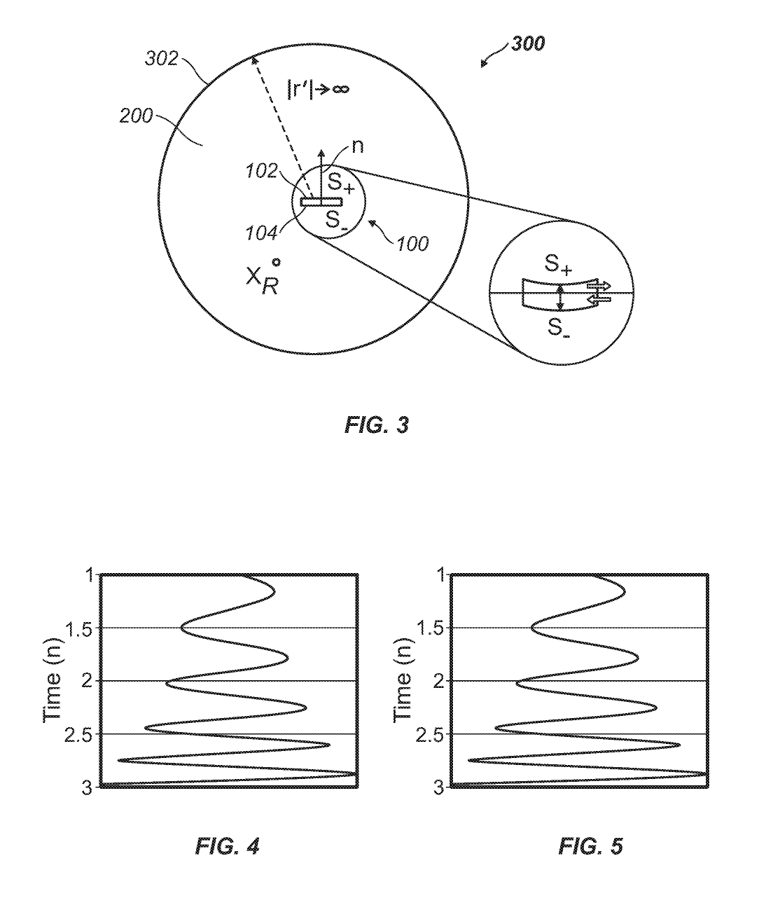

FIG. 3 illustrates a model 300 for calculating a pressure wave field 200 generated by dipole-type source 100 (e.g., FIG. 1). As illustrated, a pressure wave field 200 may be enclosed by a spherical surface 302 representing an outer border of the model and an inner surface, surrounding the oscillating first and second bender plates 102, 104 of dipole-type source 100, representing an inner border. By applying the acoustic representation theorem to model 300, the pressure wave field inside model 300 can be expressed as shown on FIG. 3 free of body forces. Model 300 can be expressed by surface integrals of the free space Green's function g, the pressure p, and the gradients of the pressure wave field and Green's function on spherical surface 302 delimiting model 300 and the inner surfaces delimiting dipole-type source 100. By letting circular surface 302 go to infinity and applying a radiation condition, such as Sommerfield's radiation condition, the pressure p can be written as a surface integral enclosing the volume of the dipole-type source:

p(x_{R},t)=∫_{S}_{₊}_{+S}_{_{−}}(g(x,x_{R},t)*∇p(x,t)−∇g(x,x_{R},t)*p(x,t))·ndS (1)

wherein p is pressure, x_{R} is position vector indicating a receiver location, t is time, S₊ is surface area of first bender plate 102, S₋ is surface area of second bender plate 104, g is the Green's function, x is position vector on the surface of integration, ∇p(x, t) is the gradient of the pressure wave field on surfaces of first bender plate 102 and second bender plate 104 as a function of x and t, ∇g(x, x_{R}, t) is the gradient of the Green's function on surfaces of first bender plate 102 and second bender plate 104 as a function of x, x_{R}, and t, n is normal vector, dS is surface element, * indicates time convolution, and ⋅ dot product. Equation 1 assumes that the surface surrounding the total removed volume is given solely by the surface areas S₊ and S₋ of the first and second bender plates 102, 104. That is, the distance between the surfaces of the first and second bender plates 102, 104 is much smaller than the surface areas S₊ and S₋ of the first and second bender plates 102, 104. Assuming the direction of the normal vector n is from S₋ to S₊ as illustrated in FIG. 3, the integral over the entire surface can be expressed as:

p(x_{R},t)=∫_{S}_{₊}(g(x,x_{R},t)*∇p(x,t)−∇g(x,x_{R},t)*p(x,t))·ndS−∫_{S}_{_{−}}(g(x,x_{R},t)*∇p(x,t)−∇g(x,x_{R},t)*p(x,t))·ndS (2)

In Equation 2, no assumptions have been made regarding the Green's functions or pressure wave fields on the surfaces of the first and second bender plates 102, 104. Continuity of the pressure gradients can be assumed such that they move in the same direction across the first and second bender plates 102, 104. That is, particle velocities across the first and second bender plates 102, 104 are the same. This is a valid assumption for first and second bender plates 102, 104 that oscillate in synchrony as in dipole-type source 100. Continuity can be imposed for the Green's functions and its derivatives across the surfaces areas S₊ and S₋. Thus, a boundary condition on the Green's functions can be imposed without affecting the generality of this example such that the Equation 2 reduces to:

p(x_{R},t)=−∫_{S}_{₊}∇g(x,x_{R},t)*[p(x,t)]·ndS (3)

The brackets [ . . . ] in Equation 3 denote the difference of pressure wave field transmitted to the surrounding liquid across the surface areas S₊ and S₋. For a homogeneous marine environment surrounding the bender plates, the free space Green's function can be used, as given by:

$$g ( x , {x}_{R} , t ) = \frac{1}{4 π} \frac{δ ( t - \frac{\vert {x}_{R} - x \vert}{c} )}{\vert {x}_{R} - x \vert} \qquad ( 4 )$$

where c is the propagation velocity in water. Equation 3 is an expression for calculating the pressure wave field generated by dipole-type source 100.

Before computing the pressure wave field generated by dipole-type source 100 from Equation 3, the gradient of the free space Green's function can be derived. Assuming the first and second bender plates 102, 104 are planar and oscillate along the z-axis, the derivative of the free space Green's function can be derived as shown in Equation 5:

$$\frac{\partial }{\partial z} g ( x , {x}_{R} , t ) = \frac{{z}_{R} - z}{{\vert {x}_{R} - x \vert}^{2}} g ( x , {x}_{R} , t ) - \frac{{z}_{R} - z}{c \vert {x}_{R} - x \vert} \frac{\partial }{\partial t} g ( x , {x}_{R} , t ) \qquad ( 5 )$$

This derivative has a term decaying with

$$\frac{1}{{\vert {x}_{R} - x \vert}^{2}} ,$$

which can affect only the near field behavior, and another term (the far field) decaying with

$$\frac{1}{\vert {x}_{R} - x \vert} ,$$

which is the term relevant for reflection seismic exploration. Note that

$$\frac{{z}_{R} - z}{\vert {x}_{R} - x \vert}$$

represents a cosine scaling, which is responsible for the directivity of dipole-type source 100.

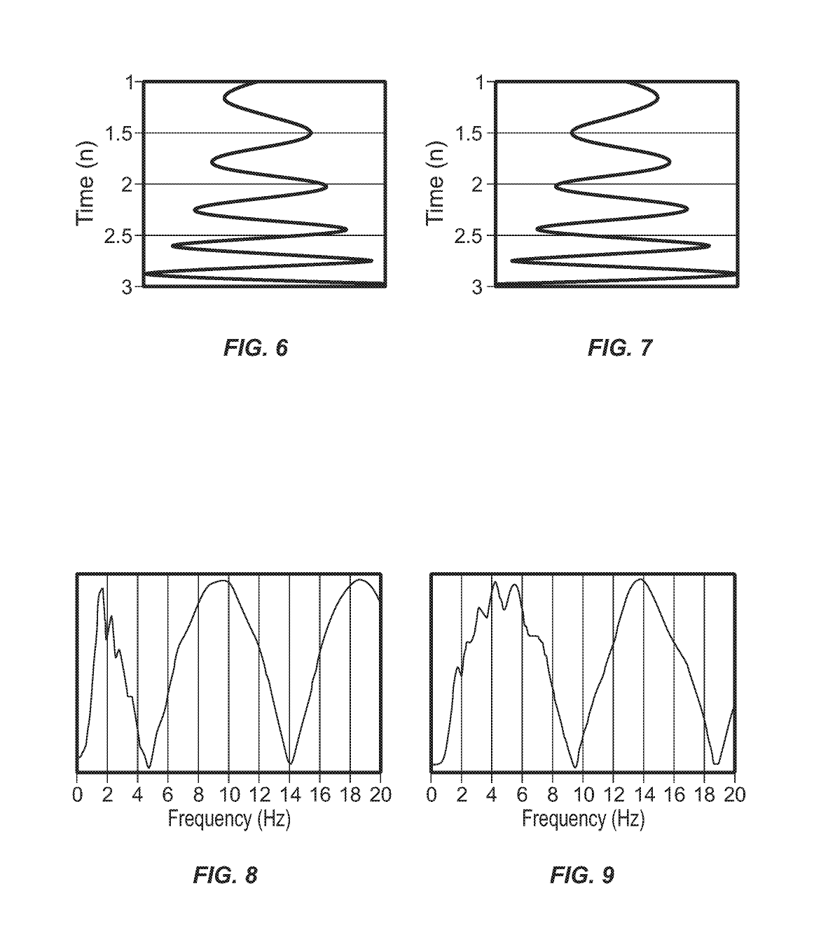

FIGS. 4-7 illustrate comparisons of computed pressure wave fields for a monopole-type source and dipole-type source 100 (e.g., FIG. 1) on FIG. 1) in homogeneous media. The monopole-type source and dipole-type source 100 are both in the form of benders. Pressure wave fields were computed above and below the monopole-type source and were also computed for dipole-type source 100 at the same distance and angle from dipole-type source 100. FIGS. 4 and 5 illustrate computed pressure wave fields from a monopole-type source, which is located at a depth of 80 meters. FIG. 4 is the computed pressure wave field at 15 meters (i.e., 65 meters above the monopole-type source) while FIG. 5 is the computed pressure wave field at 145 meters (i.e., 65 meters below the monopole-type source). FIGS. 6 and 7 illustrate computed pressure wave fields from dipole-type source 100 (e.g., FIG. 1), which is located at a depth of 80 meters. FIG. 6 is the computed pressure wave field at 15 meters (i.e., 65 meters above dipole-type source 100) while FIG. 7 is the computed pressure wave field at 145 meters (i.e., 65 meters below the dipole-type source 100). As illustrated in FIGS. 4 and 5, the pressure wave field is the same above and below the monopole-type source. In contrast, the pressure wave fields above and below dipole-type source 100 shown on FIGS. 6 and 7 have different signs (i.e., opposite polarity), which is because of the directionality of dipole-type source 100.

Accordingly, FIGS. 4-7 illustrate the different behaviors of monopole-type sources and dipole-type sources 100. The different behaviors of the monopole-type sources and the dipole-type sources 100 can be combined using an angle dependent scaling. Such a combination can be used for separating the generated pressure wave fields into upwards and downwards propagating components. Such obtained source-side wave field separation can be similar to the dual sensor separation on the receiver side.

FIGS. 8 and 9 illustrate a comparison of source ghosts for dipole-type source 100 (FIG. 8) (e.g., FIG. 1) and a monopole-type source (FIG. 9) at a depth of 80 meters where the sweeps start with a frequency of 1 hertz. FIG. 8 is an amplitude spectrum from dipole-type source 100 while FIG. 9 is an amplitude spectrum from a monopole-type source. The source ghost effect from dipole-type source 100 and monopole-type source illustrated in FIGS. 8 and 9 can be analyzed using the generated pressure wave field in a homogeneous half space with flat free surface at z=0. The two ghost functions are complementary with the amplitude spectrum starting with a maximum at a frequency of 0 hertz for dipole-type source 100 and the amplitude spectrum starting with null at a frequency of 0 hertz for the monopole-type source. Because of the spectral behavior of the ghost function for dipole-type source 100 with the highest values at the lowest frequencies, the dipole-type source may be well-suited for generating pressure wave fields with frequencies at the low frequency end of the amplitude spectra.

Accordingly, a combination of dipole-type source 100 and monopole-type sources may be suitable for generating a broad frequency band, for example, from about 0.1 Hz to about 100 Hz, and dipole-type sources 100 of very low frequencies, from about 0.1 Hz to 10 Hz, or about 0.1 Hz to 5 Hz. In at least one embodiment, the low frequencies of dipole-type source can be enhanced by the ghost function of dipole-type source 100. Dipole-type source 100 can be towed at any depth and generate very low frequency pressure wave fields. For example, dipole-type source 100 may be towed as shallow 10 m, the depths of conventional airgun sources and as deep as 75 meters, 150 meters, or even deeper.

FIGS. 10A to 10C illustrate another example embodiment of dipole-type source 100. As illustrated, dipole-type source 100 may include two sound radiating surfaces, in the form of first bender plate 102 and second bender plate 104 that may bend and flex to generate pressure waves. In the illustrated embodiment, first and second bender plates 102, 104 of FIGS. 10A to 10C may be similar in structure and function to the preceding description with respect to FIG. 1. Dipole-type source 100 may also include one or more drivers 1000, 1002. The one or more drivers 1000, 1002 will be referred to herein collectively as one or more drivers 1000, 1002 and individually as first driver 1000 and second driver 1002. One or more drivers 1000, 1002 may drive the first and second bender plates 102, 104 to generate pressure waves (e.g., down-going wave 206 and up-going wave 208 on FIG. 2A) having opposite polarity. For example, first bender plate 102 and second bender plate 104 may act in a phase opposite to the other such that the first and second bender plates 102, 104 oscillate substantially synchronously in the same direction. By oscillation substantially synchronously of first and second bender plates in the same direction, dipole-type source 100 may generate pressure waves with opposite polarity.

In the illustrated embodiment, dipole-type source 100 may include an internal cavity 106. As illustrated, internal cavity 106 may be provided between first and second bender plates 102, 104. In some embodiments, dividing wall 1008 separates internal cavity 106 into first cavity 1004 and second cavity 1006. The first cavity 1004 and the second cavity 1006 may be sealed from one another such that there is no fluid communication between the first cavity 1004 and the second cavity 1006. First and second cavities 1004, 1006 may each be configured to hold a volume of a fluid, which may be a gas, such as air or another compressible fluid or gaseous substance, or liquid, such as water. In some embodiments, the fluid may comprise pressurized air, in that the air is at a pressure greater than atmospheric pressure. The fluid in first cavity 1004 and second cavity 1006 may be the same in each of first and second cavities 1004, 1006 or different. The volume of fluid within first and second cavities 1004, 1006 may be dependent on the volume of first and second cavities 1004, 1006, which in turn would depend on their respective dimensions (e.g., diameter, length, height, etc.). In some embodiments, the volume of fluid within first and second cavities 1004, 1006 may be pressurized, for example, above atmospheric. In marine applications, for example, pressurizing and maintaining the volume of fluid within first and second cavities 1004, 1006 at an ambient hydrostatic pressure at an operating water depth may protect dipole-type source 100 from collapsing from ambient hydrostatic pressure.

As illustrated, internal cavity 106 may also include ports, such as first port 1007 and second port 1009. First and second ports 1007, 1009 may serve as apertures for transporting fluid to and from the internal cavity 106. For example, first port 1007 may serve as an aperture in outer wall 108 for transporting fluid to and from first cavity 1004, and second port 1009 may serve as an aperture in outer wall 108 for transporting fluid to and from second cavity 1006. While FIGS. 10A to 10C illustrate two ports (e.g., first port 1007 and second port 1009), it should be understood that more than two ports may be fainted in outer wall 108 for providing fluid flow into and out of internal cavity 106. Each of the first port 1007 and second port 1009 may be configured to facilitate fluid flow between internal cavity 106 and one or more drivers 1000, 1002. For example, first port 1007 may facilitate fluid flow between first cavity 1004 and first driver 1000, and second port 1009 may facilitate fluid flow between second cavity 1006 and second driver 1002.

With continued reference to FIGS. 10A to 10C, one or more drivers 1000, 1002 may be in fluid communication with the fluid in internal cavity 106. For example, first driver 1000 may be in fluid communication with first cavity 1004 and second driver 1002 may be in fluid communication with second cavity 1006. First conduit 1010 may couple first driver 1000 to first cavity 1004, and second conduit 1012 may couple second driver 1002 to second cavity 1006. While first and second conduits 1010 and 1012 are shown on FIGS. 10A to 10C, it should be understood that first and second conduits 1010 and 1012 may not be necessary for coupling one or more drivers 1000, 1002 to internal cavity 106. For example, one or more drivers 1000, 1002 may be directly coupled to outer wall 108 or first and second conduits 1010, 1012 may be internal to one or more drivers 1000, 1002.

When one or more drivers 1000, 1002 are actuated, one or more drivers 1000, 1002 may cause fluid to flow into, and out of, internal cavity 106 (e.g., flowing into first cavity 1004 while flowing out of second cavity 1006), thus causing first and second bender plates 102, 104 to bend, flex, or otherwise be deformed, resulting in vibration and output of pressure waves. By controlling actuation of one or more drivers 1000, 1002 so that the fluid entering and exiting the internal cavity 106 is controlled, first and second bender plates 102, 104 may oscillate synchronously in opposite phase. In operation, the pressure in first and second cavities 1004, 1006 and the bending of first and second bender plates 102, 104 may be in opposite phase. FIG. 10A illustrates dipole-type source 100 at rest prior to actuation of one or more drivers 1000, 1002. As illustrated on FIG. 10B, one or more drivers 1000, 1002 may be actuated to cause fluid flow into, and out of, internal cavity 106 to cause first and second bender plates 102, 104 to bend in substantial synchrony in a first direction shown by arrows 110. To cause this movement in the first direction 110, fluid may flow into second cavity 1006 while additional fluid is flowing out of first cavity 1004. As illustrated on FIG. 10C, one or more drivers 1000, 1002 may then be actuated to cause first and second bender plates 102, 104 to bend in a second direction (opposite first direction 110) direction as shown by arrows 112. To cause this movement in the second direction 112, fluid may flow out of second cavity 1006 while the additional fluid is flowing into first cavity 1004. This oscillating movement of first and second bender plates 102, 104 in first direction 110 followed by second direction 112 may be repeated for a period of time to generate a pressure wave field. As the first and second bender plates 102, 104 oscillate in substantial synchrony, dipole-type source 100 may generate an up-going wave and a down-going wave with opposite polarity.

One or more drivers 1000, 1002 may be any suitable driver for actuation of dipole-type source 100. In some embodiments, one or more drivers 1000, 1002 should cause fluid to flow into, and out of, internal cavity 106. In some embodiments, one or more drivers 1000, 1002 may be an electroacoustic transducer for generation of acoustic energy. In non-limiting embodiments, the electroacoustic transducer may generate force by vibrating a portion of its surface. In other embodiments, one or more drivers 1000, 1002 may be a linear motor, which may be a linear magnetic motor that may be energized electrically. A suitable linear motor may include stationary electric coils and a magnetic component (e.g., a magnetic cylinder) that passes through a magnetic field generated by the stationary electric coils, or vice versa.

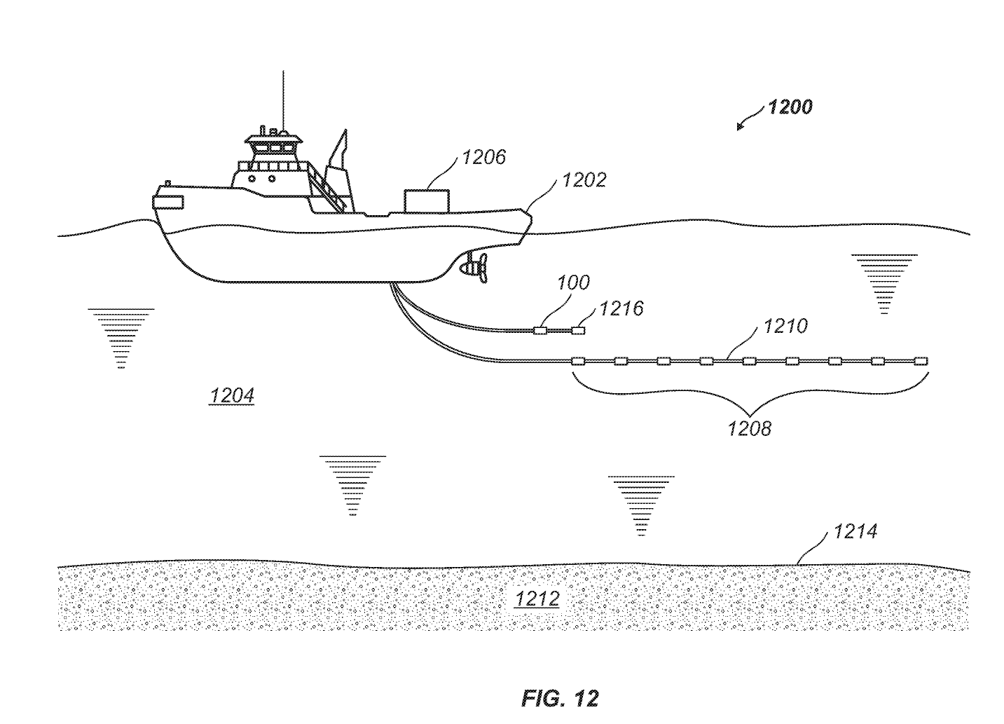

Dipole-type source 100 may further include a control system 1014. The control system 1014 may be part of a recording system (e.g., recording system 1206 on FIG. 12) or a different computer. Control system 1014 may be communicatively coupled to one or more drivers 1000, 1002 by a communication link 1016, which may be wired, wireless, or a combination thereof. Control system 1014 may include hardware and software that operate to control one or more drivers 1000, 1002. For example, control system 1004 may include a processor 1018 (e.g., microprocessor, central processing unit, etc.) that may process data by executing software or instructions obtained from a local or remote non-transitory, tangible computer readable media 1020 (e.g., optical disks, magnetic disks). Processor 1018 may include any type of computational circuit, such as a microprocessor, a complex instruction set computing (CISC) microprocessor, a reduced instruction set computing (RISC) microprocessor, a very long instruction word (VLIW) microprocessor, a digital signal processor (DSP), or any other type of processor, processing circuit, execution unit, or computational machine. It should be understood that embodiments of the control system 1014 should not be limited to the specific processors listed herein. Non-transitory, tangible computer-readable media 1020 may store software or instructions of the methods described herein. Non-transitory, tangible computer readable media 1020 may include any instrumentality or aggregation of instrumentalities that may retain data and/or instructions for a period of time. Non-transitory, tangible computer-readable media 1020 may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Control system 1014 may also include input device(s) 1022 (e.g., keyboard, mouse, touchpad, etc.) and output device(s) 1024 (e.g., monitor, printer, etc.). Input device(s) 1022 and output device(s) 1024 provide a user interface that enables an operator to interact with one or more drivers 1000, 1002 and/or software executed by processor 1018. In some embodiments, control system 1014 may take measurements from one or more sensors (not shown) to change the signal used to control one or more drivers 1000, 1002.

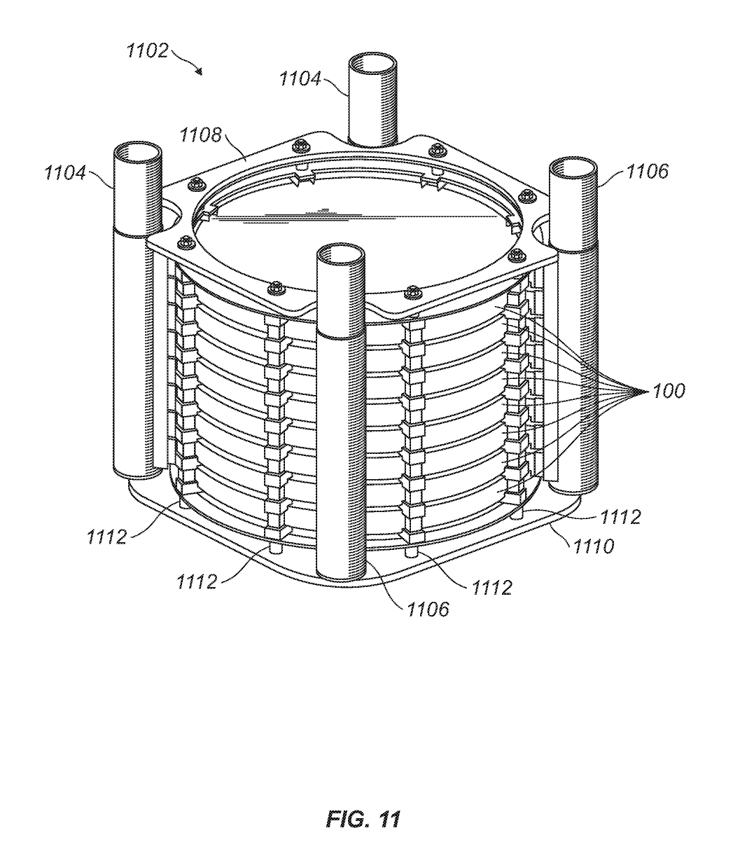

FIG. 11 illustrates a plurality of dipole-type sources 100 arranged in a stack assembly 1102. Dipole-type sources 100 in stack assembly 1102 may have the general configuration of the dipole-type source 100 described herein, for example, with respect to FIGS. 1, 2A-2B, 10A-10C, and FIG. 12. As illustrated, stack assembly 1102 may include a plurality of dipole-type sources 100 arranged in a stack configuration. Stack assembly 1102 may further comprise first manifolds 1104 and second manifolds 1106 for supplying fluid to internal cavities (e.g., internal cavity 106 on FIG. 10A) of the dipole-type sources 100. First manifolds 1104 and second manifolds 1106 may each include a hose, pipe, segment thereof, or other similar component. By way of example, first manifolds 1104 may supply fluid to first cavities (e.g., first cavity 1004 on FIG. 10A) and second manifolds 1106 may supply fluid to second cavities (e.g., second cavity 1006 on FIG. 10A). The embodiment illustrated in FIG. 11 also shows that stack assembly 1102 may include a first plate 1108 and second plate 1110 to which the dipole-type sources 100 may be coupled. First plate 1108 and second plate 1110 may function, for example, to provide structural support to stack assembly 1102. Dipole-type sources 100 may be arranged between first plate 1108 and second plate 1110 to form a stack configuration of dipole-type sources 100. In the embodiment illustrated in FIG. 11, stack assembly 1102 may further include stack support structures 1112, which may extend between first plate 1108 and second plate 1110. Stack support structures 1112 may have any suitable configuration, including, but not limited to, rods, bars, beams, and the like. Stack support structures 1112 may be coupled to the dipole-type sources 100, for example, to hold dipole-type sources 100 in place within stack assembly 1102. It should be understood that stack assembly 1102 shown on FIG. 11 is merely illustrative and other suitable configurations of dipole-type sources 100 arranged in a stack configuration may be used in particular embodiments.

FIG. 12 illustrates a marine seismic survey system 1200 in accordance with example embodiments. Marine seismic survey system 1200 may include a survey vessel 1202 that moves along the surface of a body of water 1204, such as a lake or ocean. Survey vessel 1202 may include thereon equipment, shown generally at 1206 and collectively referred to herein as a “recording system.” Recording system 1206 may include devices (none shown separately) for detecting and making a time indexed record of signals generated by each of seismic sensors 1208 (explained further below) and for actuating dipole-type source 100 at selected times. Recording system 1206 may also include devices (none shown separately) for determining the geodetic position of the survey vessel 1202 and the various seismic sensors 1208.

As illustrated, the survey vessel 1202 or a different vessel may tow dipole-type source 100. Although only a single dipole-type source 100 is shown, it should be understood that more than one dipole-type source 100 (or additional monopole-type sources) may be used, which may be towed by the survey vessel 1202 or different survey vessels, for example, as desired for a particular application. Dipole-type source 100 may include one or more of the features described herein, for example, with respect to FIGS. 1-3 and 10. Also illustrated on FIG. 12 with dipole-type source 100 is a monopole-type source 1216. Monopole-type source 1216 may also be towed by survey vessel 1202. Non-limiting examples of suitable sources for use as the monopole-type source 1216 includes air guns, marine vibrators, and benders. Although only a single monopole-type source 1216 is shown, it should be understood that more than one monopole-type source 1216 may be used. As previously mentioned, using the dipole-type source 100 in combination with the monopole-type source 1216 may be suited for generating a broad frequency band. In some embodiments, the monopole-type sources 1216 may be towed in a stack assembly 1102 (as shown on FIG. 11 with reference to dipole-type sources 100). While FIG. 11 shows stack assembly 1102 with reference to dipole-type sources 100, it should be understood that monopole-type sources 1216 may also be arranged in a stack configuration.

With continued reference to FIG. 12, survey vessel 1202 may further tow sensor streamer 1210. Sensor streamer 1210 may be towed in a selected pattern in body of water 1204 by survey vessel 1202 or a different vessel. While not shown, survey vessel 1202 may tow a plurality of sensor streamers 1210, which may be spaced apart behind the survey vessel 1202. Sensor streamers 1210 may each be formed, for example, by coupling a plurality of streamer segments (none shown separately). The configuration of sensor streamer 1210 on FIG. 12 is provided to illustrate an example embodiment and is not intended to limit the present disclosure. It should be noted that, while the present example, shows only a single sensor streamer 1210, the present disclosure is applicable to any number of sensor streamers 1210 towed by survey vessel 1202 or any other vessel. Sensor streamer 1210 may include seismic sensors 1208 thereon at spaced apart locations. Seismic sensors 1208 may be any type of seismic sensors known in the art, including, but not limited to, hydrophones, geophones, particle velocity sensors, particle displacement sensors, particle acceleration sensors, or pressure gradient sensors, for example. While not illustrated, seismic sensors 1208 may alternatively be disposed on ocean bottom cables or subsurface acquisition nodes in addition to, or in place of, sensor streamer 1210.

During operation, certain equipment (not shown separately) in the recording system 1206 (e.g., control system 1014 on FIGS. 10A-10C) may cause dipole-type source 100 to actuate at selected times. When actuated, dipole-type source 100 may produce pressure waves with opposite polarity (e.g., down-going wave 206 and up-going wave 208 on FIGS. 2A and 2B). The pressure waves may travel downwardly through the body of water 1204 and may pass, at least in part, through one or more formations 1212 below water bottom 1214. Pressure waves may be at least partially reflected in one or more formations 1212 and then travel upwardly for detection at seismic sensors 1208. Seismic sensors 1208 may generate response signals, such as electrical or optical signals, in response to detecting the pressure waves emitted from dipole-type source 100 after interaction with one or more formations 1212. Signals generated by seismic sensors 1208 may be communicated to recording system 1206. Structure of one or more formations 1212 among other properties, may be inferred, for example, by analysis of the detected energy, such as its amplitude, phase, and travel time.

In accordance with example embodiments, a geophysical data product may be produced from the detected pressure waves. The geophysical data product may be used to evaluate certain properties of one or more formations 1212. The geophysical data product may include acquired and/or processed seismic data and may be stored on a non-transitory, tangible computer-readable medium. The geophysical data product may be produced offshore (i.e., by equipment on a vessel) or onshore (i.e., at a facility on land) either within the United States and/or in another country. Specifically, embodiments may include producing a geophysical data product from at least the measured seismic energy and recording the geophysical data product on a non-transitory, tangible computer-readable medium suitable for importing onshore. If the geophysical data product is produced offshore and/or in another country, it may be imported onshore to a facility in, for example, the United States or another country. Once onshore in, for example, the United States (or another country), further processing and/or geophysical analysis may be performed on the geophysical data product.

The particular embodiments disclosed above are illustrative only, as the described embodiments may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. All numbers and ranges disclosed above may vary by some amount. Whenever a numerical range with a lower limit and an upper limit is disclosed, any number and any included range falling within the range are specifically disclosed. Moreover, the indefinite articles “a” or “an,” as used in the claims, are defined herein to mean one or more than one of the element that it introduces. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted for the purposes of understanding this disclosure.

What is claimed is:

1. A dipole-type source comprising:
a first bender plate;
a second bender plate;
a first cavity coupled to the first bender plate;
a second cavity coupled to the second bender plate; and
one or more drivers in fluid communication with the first cavity and/or the second cavity, wherein the one or more drivers are operable to drive a respective fluid between at least one of the one or more drivers and the first cavity and between at least one of the one or more drivers and the second cavity, such that the first bender plate and the second bender plate oscillate at least substantially synchronously in the same direction to generate an up-going wave and a down-going wave with opposite polarity.

2. The dipole-type source of claim 1, further comprising an outer wall coupled to the first bender plate and the second bender plate, the outer wall coupling the first bender plate to the second bender plate.

3. The dipole-type source of claim 2, wherein a first port for fluid flow between the first cavity and the one or more drivers is formed in the outer wall, and a second port for fluid flow between the second cavity and the one or more drivers is formed in the outer wall.

4. The dipole-type source of claim 1, further comprising a dividing wall separating the first cavity and the second cavity, wherein the first cavity and the second cavity are sealed from one another.

5. The dipole-type source of claim 1, further comprising a control system operable to cause the one or more drivers to drive a portion of the fluid into the first cavity while another portion of the fluid is driven from the second cavity.

6. The dipole-type source of claim 1, wherein the fluid comprises pressurized air.

7. The dipole-type source of claim 1, wherein the one or more drivers are selected from the group consisting of a linear motor and an electroacoustic transducer.

8. A marine seismic survey system, comprising:
a dipole-type source towable from a survey vessel, wherein the dipole-type source comprises two sound radiating surfaces and one or more drivers, wherein the one or more drivers are operable to cause the two sound radiating surfaces to oscillate at least substantially synchronously in the same direction to generate an up-going wave and a down-going wave with opposite polarity; and
seismic sensors for measuring a pressure wave field generated by the dipole-type source.

10. The marine seismic survey system of claim 9, wherein the seismic sensors are disposed on a streamer, an ocean bottom cable, or subsurface acquisition nodes.

11. The marine seismic survey system of claim 9, wherein the dipole-type source comprises a first cavity and a second cavity, and wherein the dipole-type source further comprises a first port for fluid flow between the first cavity and the one or more drivers and a second port for fluid flow between the second cavity and the one or more drivers.

12. The marine seismic survey system of claim 11, wherein the dipole-type source further comprises a control system operable to cause the one or more drivers to drive a fluid into the first cavity while additional fluid is driven from the second cavity such that the two sound radiating surfaces are caused to oscillate.

13. The marine seismic survey system of claim 9, wherein the two sound radiating surfaces comprises a first bender plate and a second bender plate, wherein the dipole-type source further comprises a first cavity coupled to the first bender plate and a second cavity coupled to the second bender plate, and wherein the one or more drivers are operable to drive a respective fluid into the internal cavity while additional fluid is driven from the internal cavity such that the first bender plate and the second bender plate oscillate at least substantially synchronously in the same direction.

14. The marine seismic survey system of claim 9, further comprising a plurality of dipole-type sources arranged in a stack assembly.

15. The marine seismic survey system of claim 14, further comprising a plurality of monopole-type sources arranged in a stack assembly operable to generate wave fields that combined with wave fields from the dipole-type sources.

16. A method for marine seismic surveying comprising:
towing a dipole-type source in a body of water; and
operating the dipole-type source in the body of water such that two sound radiating surfaces oscillate at least substantially synchronously to generate a pressure wave field comprising an up-going wave and a down-going wave with opposite polarity.

17. The method of claim 16, wherein the two sound radiating surfaces comprise a first bender plate and a second bender plate, and wherein the operating the dipole-type source in the body of water comprises causing the first bender plate and the second bender plate to bend.

18. The method of claim 17, wherein the operating the dipole-type source in the body of water comprises:
flowing fluid out of a first cavity behind the first bender plate while flowing additional fluid into a second cavity behind the second bender plate to cause the first bender plate and the second bender plate to move in a first direction; and
flowing the fluid into the first cavity while flowing the additional fluid out of the second cavity to cause the first bender plate and the second bender plate to move in a second direction opposite the first direction.

19. A method of manufacturing a geophysical data product comprising:
operating a dipole-type source in a body of water such that two sound radiating surfaces oscillate at least substantially synchronously to generate a pressure wave field comprising an up-going wave and a down-going wave with opposite polarity;
obtaining geophysical data from measurements of the pressure wave field; and
processing the geophysical data to produce a geophysical data product.

20. The method of claim 19, further comprising recording the geophysical data product on a non-transitory, tangible computer-readable medium.
